(19) United States
(12) Patent Application Publication
(10) Pub. No.: US 2025/0079776 A1
(43) Pub. Date: Mar. 6, 2025

(54) RELAY CONNECTOR

(71) Applicant: SUMITOMO WIRING SYSTEMS, LTD., Yokkaichi-shi (JP)

(72) Inventor: Junya ITO, Yokkaichi-shi (JP)

(73) Assignee: SUMITOMO WIRING SYSTEMS, LTD., Yokkaichi-shi (JP)

(21) Appl. No.: 18/809,565

(22) Filed: Aug. 20, 2024

(30) Foreign Application Priority Data
Aug. 29, 2023 (JP) 2023-139169

(51) Int. Cl. H01R 13/74; H01R 13/52

(52) U.S. Cl. CPC H01R 13/74; H01R 13/5202; H01R 2201/26

(57) ABSTRACT

A relay connector that is configured to be attached to a device case to electrically connect an inside and an outside of the device case, the relay connector including: a terminal; a connector housing that holds the terminal; and a seal that is configured to seal between the connector housing and the device case, the seal having: an annular seal body that is configured to be sandwiched and compressed between the connector housing and the device case; and a fixing piece extending from the seal body outward of the seal body, and the connector housing having a positioning column that is configured to be fitted into a positioning recess provided in the device case, the positioning column extending through the fixing piece and holding the fixing piece.

### BACKGROUND

The present disclosure relates to a relay connector.

For example, JP 2018-125078A describes a relay connector to be attached to a device case. The relay connector is a connector for electrically connecting the inside and outside of the device case. The relay connector includes a terminal, a connector housing that holds the terminal, and a seal member for sealing between the connector housing and the device case. The seal member has an annular seal body and a plurality of locking pieces extending inward from the seal body. The connector housing has locking protrusions at positions corresponding to the respective locking pieces of the seal member. The locking protrusions are inserted into respective holes provided in the locking pieces of the seal member. The seal member is thus held by the connector housing. The seal body of the seal member is sandwiched and compressed between the connector housing and the device case, thereby achieving sealing between the connector housing and the device case.

### SUMMARY

When the connector housing of the above relay connector needs to be positioned relative to the device case, it is conceivable to provide the connector housing with a positioning protrusion that can fit into a recess provided in the device case. However, simply providing a positioning protrusion in a connector housing such as that described in JP 2018-125078A may increase the size of the connector housing.

An exemplary aspect of the disclosure provides a relay connector that can be downsized.

A relay connector of the present disclosure is a relay connector that is configured to be attached to a device case to electrically connect an inside and an outside of the device case, the relay connector including: a terminal; a connector housing that holds the terminal; and a seal that is configured to seal between the connector housing and the device case, the seal having: an annular seal body that is configured to be sandwiched and compressed between the connector housing and the device case; and a fixing piece extending from the seal body outward of the seal body, and the connector housing having a positioning column that is configured to be fitted into a positioning recess provided in the device case, the positioning column extending through the fixing piece and holding the fixing piece.

According to the relay connector of the present disclosure, downsizing can be achieved.

### BRIEF DESCRIPTION OF THE DRAWINGS

FIG. 1 is a front view of a relay connector according to an embodiment.

FIG. 2 is a perspective view of the relay connector according to the embodiment.

FIG. 3 is a bottom view of the relay connector according to the embodiment.

FIG. 4 is a cross-sectional view of FIG. 3 taken along line 4-4.

### DETAILED DESCRIPTION OF EMBODIMENTS

Firstly, modes for implementation of the present disclosure will be listed and described.

A relay connector of the present disclosure is:
[1] a relay connector that is to be attached to a device case to electrically connect inside and outside of the device case, and includes: a terminal; a connector housing holding the terminal; and a seal member for sealing between the connector housing and the device case, the seal member having: an annular seal body to be sandwiched and compressed between the connector housing and the device case; and a fixing piece extending from the seal body outward of the seal body, and the connector housing having a positioning column to be fitted into a positioning recess provided in the device case, the positioning column extending through the fixing piece and holding the fixing piece.

According to this configuration, the positioning column of the connector housing can be used for both positioning relative to the device case and fixation of the seal member. It is therefore possible to downsize the connector housing compared to a configuration in which a protrusion for positioning relative to the device case and a protrusion for fixing the seal member are provided separately.
[2] In the above item [1], the positioning column may have a retaining structure preventing the fixing piece from coming off from the positioning column.

According to this configuration, the retaining structure provided in the positioning column can prevent the fixing piece of the seal member from coming off from the positioning column.
[3] In the above item [2], the positioning column may have a cutout serving as the retaining structure and formed in an outer face of the positioning column, and the fixing piece may be locked at the cutout.

According to this configuration, the fixing piece can be prevented more preferably from coming off from the positioning column by locking the fixing piece of the seal member at the cutout provided in the positioning column.
[4] In any of the above items [1] to [3], the connector housing may have: a fixing flange to be fixed to the device case so as to cover an opening portion provided in the device case; and an insertion portion to be inserted into the opening portion, the insertion portion extending from the fixing flange, the fixing flange may have: an annular accommodating groove accommodating the seal body; and a fixed portion to be fixed to the device case, and the fixed portion and the positioning column are located in an outer region of the fixing flange relative to the accommodating groove.

According to this configuration, an outer region of the accommodating groove in the fixing flange is a region necessary for providing the fixed portion on the outer side of the accommodating groove. It is thus possible to simplify the configuration of the inner side of the accommodating groove in the fixing flange by providing the positioning column together with the fixed portion in the outer region of the accommodating groove in the fixing flange. The fixing flange can therefore be downsized by shortening the length between the insertion portion and the accommodating groove in the fixing flange. Further, it is possible to shorten the lengths of the accommodating groove and the seal body accommodated in the accommodating groove in the circumferential direction, which contributes to improving sealing performance of the seal body.

### DETAILS OF EMBODIMENTS OF PRESENT DISCLOSURE

Specific examples of a relay connector of the present disclosure will be described below with reference to the drawings. The drawings may partially exaggerate or simplify configurations for convenience of illustration. The dimensional ratio of each part may differ between the drawings. The terms “parallel” and “orthogonal” as used herein include not only the case of being strictly parallel and orthogonal but also the case of being substantially parallel and orthogonal within a range that exhibits the operation and effects of the present embodiment. Note that the term “annular” used in the description of the present specification may refer to any structure that forms a loop, a continuous shape without an end, or a generally loop-shaped structure with a gap, such as a C-shape. Note that “annular” shapes include a circular shape, an elliptical shape, and a polygonal shape having sharp or round angles, but are not limited thereto. The term “opposing” as used herein means that faces or members are at positions directly facing each other, and includes not only the case of being at positions entirely facing each other but also the case of being at positions partially facing each other. Further, the term “opposing” as used herein includes both the case where another member is interposed between two parts and the case where nothing is interposed between two parts. The terms “first”, “second”, and so on, are used only to distinguish between objects and not intended to rank the objects. Note that the present disclosure is not limited to these examples but is defined by the claims, and is intended to include all modifications made within the meaning and scope equivalent to the claims.

### Overall Configuration

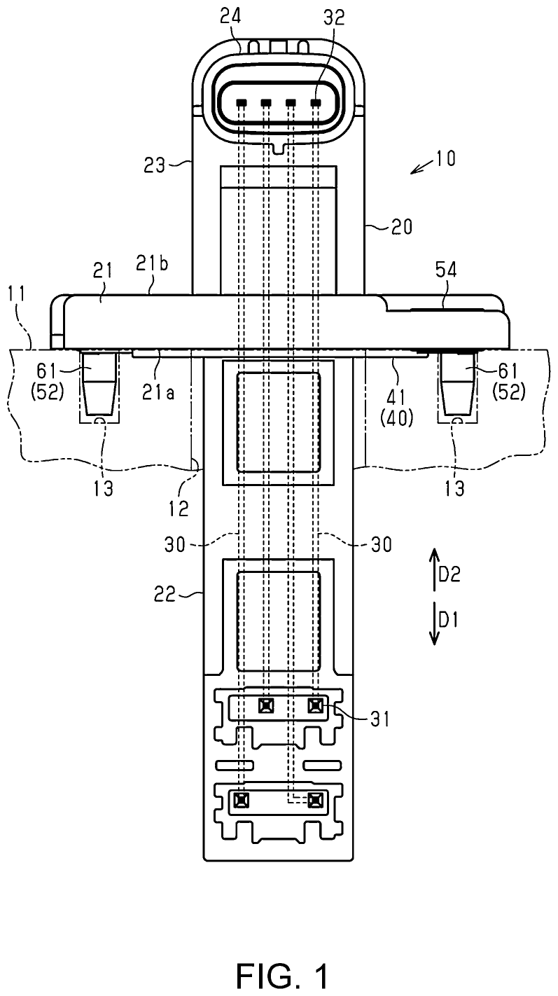

As shown in FIG. 1, a relay connector 10 is attached to a device case 11, which is mounted in a vehicle. The relay connector 10 is fixed to the device case 11 by means of bolts or the like, for example. The relay connector 10 is a connector for electrically connecting the inside and outside of the device case 11. The device case 11 is, for example, a transmission case. The device case 11 is made of metal, for example. The inside of the device case 11 is an oil environment, and the outside of the device case 11 is an air environment, for example. The device case 11 contains, for example, electrical components such as a motor and a sensors. The device case 11 has an opening portion 12 (opening), through which the relay connector 10 extends. The opening portion 12 is formed in the device case 11 so as to connect an interior space to an exterior space of the device case 11. The relay connector 10 is attached into the opening portion 12 of the device case 11 along a first direction D1. In the following description, a direction opposite to the first direction D1 is referred to as a second direction D2.

### Configuration of Relay Connector 10

The relay connector 10 includes a connector housing 20, terminals 30, and a seal member 40 (seal). The connector housing 20 is, for example, made of an insulator such as synthetic resin. The relay connector 10 includes a plurality of terminals 30, for example. Each terminal 30 is made of a conductor. The terminals 30 are held by the connector housing 20.

### Configuration of Connector Housing 20

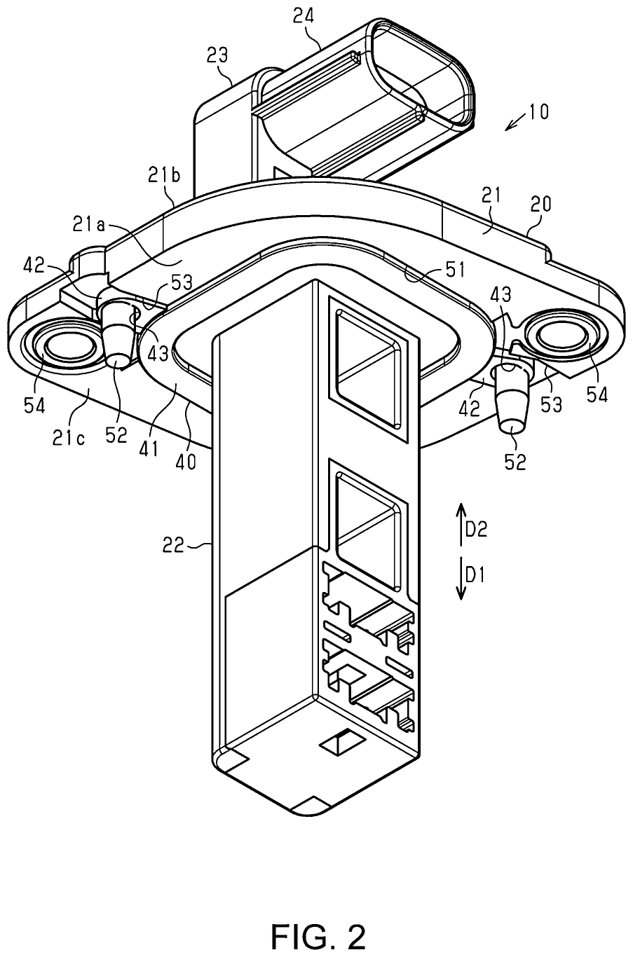

As shown in FIGS. 1 and 2, the connector housing 20 includes a fixing flange 21, an internal connecting portion 22 serving as an insertion portion (insertion), and an external connecting portion 23.

The fixing flange 21 has a flat shape extending along a plane perpendicular to the first direction D1, for example. The fixing flange 21 is fixed by means of bolts or the like to an outer surface of the device case 11 so as to cover the opening portion 12. A side face of the fixing flange 21 that faces the device case 11 in the first direction D1 is referred to as a first side face 21a, and a side face opposite to the first side face 21a is referred to as a second side face 21b.

The internal connecting portion 22 extends in the first direction D1 from the first side face 21a of the fixing flange 21, for example. The internal connecting portion 22 is inserted into the opening portion 12 of the device case 11 in the first direction D1. The external connecting portion 23 extends from the second side face 21b of the fixing flange 21. The external connecting portion 23 is provided with a fitting portion 24, to which a mating connector (not shown) is fitted. Note that the fitting portion 24 may be potted.

As shown in FIG. 1, each terminal 30 of the relay connector 10 is partially embedded in the connector housing 20. Each terminal 30 has a first connection end 31 exposed in the internal connecting portion 22 and a second connection end 32 exposed in the fitting portion 24 of the external connecting portion 23. The first the connection end 31 of each terminal 30 is electrically connected to an internal component (not shown) provided within the device case 11. The second connection end 32 of each terminal 30 is electrically connected to the mating connector fitted to the fitting portion 24. The mating connector is provided in a control unit that accommodates a control circuit or the like, for example. That is, the control circuit provided in the control unit is electrically connected to the internal component via the relay connector 10.

### Configuration of Seal Member 40

The seal member 40 is provided so as to be sandwiched between the fixing flange 21 and the outer surface of the device case 11. As shown in FIG. 2, the seal member 40 has an annular seal body 41 and fixing pieces 42 that extend outward of the seal body 41 from an outer edge of the seal body 41. Each fixing piece 42 has a through hole 43 extending through the fixing piece 42. The seal member 40 of the present embodiment has two fixing pieces 42, for example. The entire seal member 40, including the seal body 41 and the fixing pieces 42, is made of an elastic body, such as rubber.

### Detailed Configuration of Fixing Flange 21

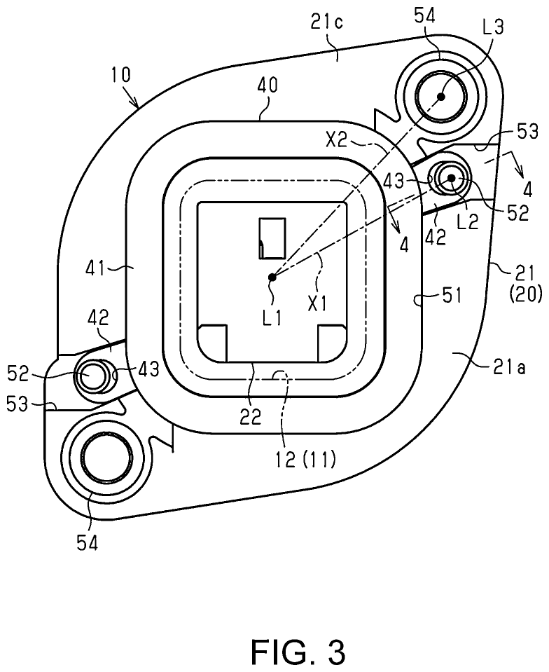

As shown in FIGS. 2 and 3, the fixing flange 21 has an annular accommodating groove 51 provided in the first side face 21a, and positioning columns 52 provided on the outer side of the accommodating groove 51 in the first side face 21a. The accommodating groove 51 surrounds the internal connecting portion 22 when viewed in the second direction D2. The accommodating groove 51 accommodates the seal body 41 of the seal member 40. A portion of the seal body 41 protrudes from the accommodating groove 51 in the first direction D1 in a state before the fixing flange 21 is fixed to the device case 11.

The fixing flange 21 has an outer portion 21c, which is an outer region of the fixing flange 21 relative to the accommodating groove 51. The outer portion 21c has fixing-piece accommodating grooves 53 that accommodate the fixing pieces 42 in the first side face 21a of the fixing flange 21. The number of fixing-piece accommodating grooves 53 is the same as the number of fixing pieces 42. In the present embodiment, two fixing-piece accommodating grooves 53 are provided. The fixing-piece accommodating grooves 53 extend outward from an outer edge of the accommodating groove 51 when viewed in the second direction D2. For example, the fixing-piece accommodating grooves 53 extend from the outer edge of the accommodating groove 51 to an outer edge of the fixing flange 21.

Cylindrical collars 54, each of which serves as a fixed portion to be fixed to the device case 11, are embedded in the outer portion 21c of the fixing flange 21, for example. The collars 54 are made of metal, for example. That is, the collars 54 are separate bodies from the resin member that forms the fixing flange 21, for example. The collars 54 are arranged such that the extending direction thereof is parallel with the first direction D1. Two collars 54 are provided in the outer portion 21c of the fixing flange 21, for example. A bolt for fastening the fixing flange 21 to the device case 11 is inserted into each collar 54. That is, regions of the outer portion 21c of the fixing flange 21 that include the collars 54 are fastened to the device case 11 by means of the bolts.

### Configuration of Positioning Column 52

The fixing flange 21 has two positioning columns 52, for example. The positioning columns 52 are provided in the two respective fixing-piece accommodating grooves 53 in the outer portion 21c of the fixing flange 21. The positioning columns 52 extend in the first direction D1 from the fixing-piece accommodating grooves 53. As shown in FIG. 3, a distance X1 from a central axis L1 of the seal body 41 to an axis L2 of the positioning column 52 is shorter than a distance X2 from the central axis L1 of the seal body 41 to an axis L3 of the collar 54 when viewed in the second direction D2. The central axis L1 and the axes L2 and L3 are parallel with the first direction D1.

The two positioning columns 52 of the fixing flange 21 are provided at positions that are point-symmetric about the central axis L1 of the seal body 41. The two collars 54 are provided at positions that are point-symmetric about the central axis L1 of the seal body 41. This allows the seal member 40 to be attached to the accommodating groove 51 and the positioning columns 52 of the fixing flange 21 even when the seal member 40 is rotated 180 degrees about the central axis L1. Note that when the seal member 40 is rotated 90 degrees about the central axis L1 from the state shown in FIG. 3 and then attached to the fixing flange 21, each fixing piece 42 of the seal member 40 is sandwiched between the outer portion 21c of the fixing flange 21 and the device case 11. This makes it easier for an operator to notice incorrect fitting of the seal member 40.

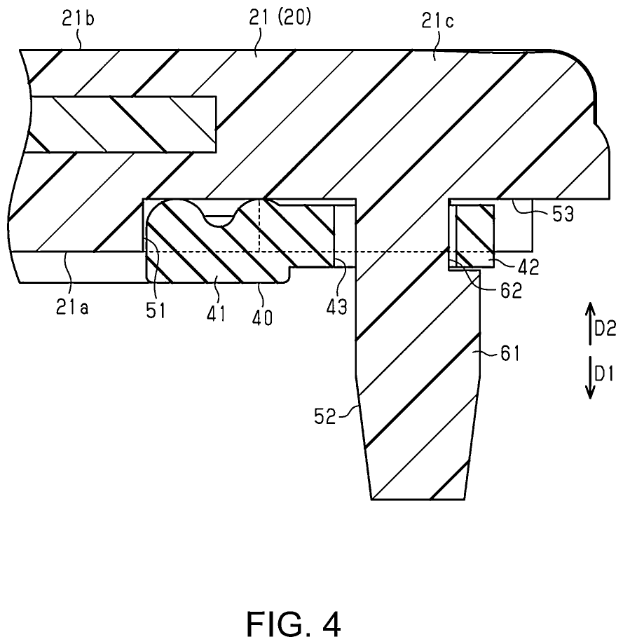

As shown in FIG. 4, each positioning column 52 has a column body 61, which is to be fitted to a corresponding positioning recess 13, and a cutout 62 formed at a base end of the positioning column 52. The cutout 62 is provided in the positioning column 52 as a retaining structure for preventing a corresponding fixing piece 42 of the seal member 40 from coming off from the positioning column 52. The cutout 62 is shaped by cutting out an outer face of the positioning column 52 to the inner diameter side. The cutout 62 is provided at a portion of the positioning column 52 in the circumferential direction, for example. Further, the cutout 62 includes an angular position of the positioning column 52 in the circumferential direction that is farthest from the accommodating groove 51. The column body 61 is a region of the positioning column 52 in which the cutout 62 is not formed. The column body 61 has a lateral cross section having a circular shape, for example.

Each positioning column 52 is inserted into a through hole 43 in a corresponding fixing piece 42 of the seal member 40. Each fixing piece 42 is locked at the cutout 62 formed at the base end of the corresponding positioning column 52. That is, the seal body 41 is kept accommodated in the accommodating groove 51 due to each fixing piece 42 being caught in the first direction D1 at the cutout 62 of the corresponding positioning column 52.

As shown in FIG. 1, the column body 61 of each positioning column 52 is fitted in the first direction D1 to the corresponding positioning recess 13 provided in the device case 11. The cross section of each positioning recess 13 that is perpendicular to the first direction D1 has a circular shape, similar to the shape of the column body 61, for example. The column body 61 of the positioning column 52 is fitted into the positioning recess 13, thereby positioning the fixing flange 21 in the direction perpendicular to the first direction D1. Positioning the fixing flange 21 using the positioning column 52 and the positioning recess 13 improves workability when bolting the fixing flange 21 to the device case 11, for example. Thus, a portion of the positioning column 52 including a leading end thereof is fitted into the positioning recess 13, and the fixing piece 42 of the seal member 40 is locked at the base end of the positioning column 52.

Next, operation of the present embodiment will be described.

When the seal member 40 is attached to the fixing flange 21 of the connector housing 20, the positioning columns 52 are inserted into the through holes 43 in the respective fixing pieces 42 of the seal member 40, and the fixing pieces 42 are locked at the cutouts 62 of the positioning columns 52. The fixing pieces 42 are locked at the cutouts 62 and thus prevented from coming off from the positioning columns 52, thereby keeping the seal body 41 accommodated in the accommodating groove 51.

When the connector housing 20 is attached to the device case 11, the internal connecting portion 22 is inserted into the opening portion 12 in the device case 11 in the first direction D1. Then, the column body 61 of each positioning column 52 is fitted into the corresponding positioning recess 13 in the device case 11 in the first direction D1. The fixing flange 21 is thus positioned relative to the device case 11 in the direction perpendicular to the first direction D1. The seal body 41 accommodated in the accommodating groove 51 is sandwiched and compressed between the fixing flange 21 and the device case 11 at a position surrounding the opening portion 12 of the device case 11. Sealing between the fixing flange 21 and the device case 11 is thus achieved by the seal body 41.

Effects of the present embodiment will be described.
(1) The connector housing 20 has the positioning columns 52 that extend through the fixing pieces 42 and hold these fixing piece 42 and are fitted into the positioning recesses 13 provided in the device case 11. According to this configuration, the positioning columns 52 of the connector housing 20 can be used for both positioning relative to the device case 11 and fixation of the seal member 40. It is therefore possible to downsize the connector housing 20 compared to a configuration in which a protrusion for positioning relative to the device case 11 and a protrusion for fixing the seal member 40 are provided separately.
(2) Each positioning column 52 has the cutout 62 formed in the outer face of the positioning column 52 as a retaining structure for preventing the fixing piece 42 from coming off from the positioning column 52. Each fixing piece 42 is locked at the corresponding cutout 62. According to this configuration, the fixing piece 42 of the seal member 40 can be more preferably prevented from coming off from the positioning column 52 by locking the fixing piece 42 at the cutout 62 provided in the positioning column 52. This can prevent the seal member 40 from coming off from the fixing flange 21.
(3) The connector housing 20 has the fixing flange 21 that is fixed to the device case 11 so as to cover the opening portion 12 of the device case 11, and the internal connecting portion 22 serving as an insertion portion that extends from the fixing flange 21 and is inserted into the opening portion 12. The fixing flange 21 has an annular accommodating groove 51 that accommodates the seal body 41, and the collars 54 serving as fixed portions that are fixed to the device case 11. Each collar 54 and positioning column 52 are located in a region on the outer side (i.e. the outer portion 21c) of the accommodating groove 51 in the fixing flange 21. According to this configuration, the outer portion 21c of the fixing flange 21 is a region necessary for providing the collars 54 on the outer side of the accommodating groove 51. It is thus possible to simplify the configuration of the inner side of the accommodating groove 51 in the fixing flange 21 by providing the positioning columns 52 together with the collars 54 in the outer portion 21c of the fixing flange 21. The fixing flange 21 can therefore be downsized by shortening the length between the insertion portion and the accommodating groove 51 in the fixing flange 21. Further, it is possible to shorten the length of the accommodating groove 51 and the seal body 41 accommodated in the accommodating groove 51 in the circumferential direction, which contributes to improving sealing performance of the seal body 41.

### Other Embodiments

The above embodiment can be modified and implemented as follows. The above embodiment and the following modifications can be implemented in combination as long as no technical contradiction arises.
Each positioning column 52 of the above embodiment has the cutout 62 as a retaining structure for the fixing piece 42, but this need not necessarily be the case. For example, each positioning column 52 may have, instead of the cutout 62, a protrusion protruding outward from the entire periphery of, or a portion in the circumferential direction of the outer face of the column body 61 as a retaining structure for the fixing piece 42. In this case, the fixing piece 42 is attached on the base end side relative to the protruding portion of the positioning column 52. With this configuration, the protrusion of the positioning column 52 can prevent the fixing piece 42 from coming off from the positioning column 52.
The cutout 62 may be provided over the entire periphery of the positioning column 52 of the above embodiment.
The number of positioning columns 52 of the fixing flange 21 is not limited to two as in the above embodiment, and may alternatively be one, or three or more, for example.
The number of fixing pieces 42 of the seal member 40 is not limited to two as in the above embodiment, and may alternatively be one, or three or more, for example. It is preferable that the number of fixing pieces 42 is equal to or less than the number of positioning columns 52.
The fixing flange 21 of the above embodiment may have, instead of the collars 54, bolt insertion holes extending through the resin portion of the fixing flange 21. Bolts for fixation to the device case 11 are inserted into those bolt insertion holes. In this case, regions of the fixing flange 21 that include the bolt insertion holes are each configured as a fixed portion to be fixed to the device case 11.
The seal member 40 of the above embodiment may be made of an elastic body other than rubber.
The above embodiment is implemented as the relay connector 10 to be attached to the device case 11, which is a transmission case, but this need not necessarily be the case. For example, the above embodiment may be applied to a relay connector for use in a device case other than a transmission case. Note that the environment inside the device case 11 to which the relay connector 10 is attached is not limited to an oil environment, and the above embodiment can also be applied to a relay connector for a device in a device case 11 within which oil is not used.

The embodiment disclosed herein is an example in all respects, and the disclosure is not limited to the example. That is, the scope of the present disclosure is defined by the claims, and is intended to encompass all modifications within the meaning and scope equivalent to the claims.

What is claimed is:

1. A relay connector that is configured to be attached to a device case to electrically connect an inside and an outside of the device case, the relay connector comprising:
a terminal;
a connector housing that holds the terminal; and
a seal that is configured to seal between the connector housing and the device case,
the seal having:
an annular seal body that is configured to be sandwiched and compressed between the connector housing and the device case; and
a fixing piece extending from the seal body outward of the seal body, and
the connector housing having a positioning column that is configured to be fitted into a positioning recess provided in the device case, the positioning column extending through the fixing piece and holding the fixing piece.

2. The relay connector according to claim 1,
wherein the positioning column has a retaining structure that prevents the fixing piece from coming off from the positioning column.

3. The relay connector according to claim 2, wherein:
the positioning column has a cutout that serves as the retaining structure and is formed in an outer face of the positioning column, and
the fixing piece is locked at the cutout.

4. The relay connector according to claim 1,
wherein the connector housing has:
a fixing flange that is configured to be fixed to the device case so as to cover an opening provided in the device case; and
an insertion that is configured to be inserted into the opening, the insertion extending from the fixing flange,
the fixing flange has:
an annular accommodating groove that accommodates the seal body; and
a fixed portion that is configured to be fixed to the device case, and
the fixed portion and the positioning column are located in an outer region of the fixing flange relative to the accommodating groove.
